(19) United States
(12) Patent Application Publication
(10) Pub. No.: US 2010/0118668 A1
(43) Pub. Date: May 13, 2010

(54) OPTICAL DISK DRIVE

(75) Inventor: Motoyuki SUZUKI, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi Consumer Electronics Co., Ltd., Tokyo (JP)

(21) Appl. No.: 12/603,260

(22) Filed: Oct. 21, 2009

(30) Foreign Application Priority Data
Nov. 7, 2008 (JP) 2008-286047

(51) Int. Cl. G11B 7/00

(52) U.S. Cl. 369/44.25; G9B/7

(57) ABSTRACT

Rotation synchronization detection means is provided which detects a specified rotational phase having a period of one revolution of an optical disk. An output of the rotation synchronization detection means is synchronized with an output of rotation phase detection means for detecting a rotation phase on the basis of a FG signal and thereafter, information of surface vibration component and eccentricity component is memorized in memories before a sleep process in accordance with the output of the rotation phase detection means or a timing until jump is determined in accordance with the output of the rotation phase detection means and during recovery from the sleep status of stopping the disk once, the output of the rotation synchronization detection means is again synchronized with the output of the rotation phase detection means adapted to detect the rotation phase on the basis of the FG signal.

### INCORPORATION BY REFERENCE

The present application claims priority from Japanese application JP2008-286047 filed on Nov. 7, 2008, the content of which is hereby incorporated by reference into this application.

### BACKGROUND OF THE INVENTION

The present invention relates to such an apparatus for recording or reproducing information on or from an optical disk as typified by an optical disk drive, for example, and more particularly, to an optical disk drive for performing such a process as focus control or tracking control in synchronism with the phase of rotation of a disk.

In an optical disk drive for recording or reproducing information by irradiating an optical beam on a disk-shaped information recording medium called an optical disk while rotating the same, surface vibration due to a warp of the optical disk and/or an eccentricity due to misalignment between the rotary shaft of a spindle motor adapted to rotate the disk and the center of a track on the optical disk causes an external disturbance affecting focus control and tracking control. The external disturbances attributable to the surface vibration and the eccentricity give rise to causes of defocusing of the optical beam and a track follow-up error or, in the case of a multi-layer disk, a failure in focus jump and a failure in track jump for moving the optical beam toward a track. These external disturbances increase as the rotational speed of the disk increases and therefore, there arises a serious problem when speedup of information recording or reproduction is to be achieved by increasing the rotational speed of the disk.

To solve this problem, a control method has hitherto been available which takes advantage of the fact that the external disturbances due to surface vibration and eccentricity are generated periodically in synchronism with the rotation of disk.

For example, JP-A-2000-20967 proposes a method of stably performing focus jump and track jump by memorizing the surface vibration and eccentricity components which are dependant on the rotation of disk while making the correspondence between them and the phase of rotation of the optical disk.

JP-A-2006-12296, on the other hand, proposes a method of stably performing focus jump by making a jump to a target recording layer at a predetermined timing synchronous with the rotation of the optical disk.

### SUMMARY OF THE INVENTION

In the conventional methods as above, in order to memorize the surface vibration and eccentricity components synchronously with the rotation of the optical disk or to determine the timing to make a jump, FG (Frequency Generator) signals are used which are outputted at intervals of predetermined rotation angles of the spindle motor. In one method for detection of the FG signal, a change in magnetic field generated from a magnetized rotor is detected by means of a Hall sensor mounted to the spindle motor and in another method, the FG signal detection is achieved through counter electromotive force generated in the motor. In these methods, as the rotation speed of the motor becomes very low, the rate of change in level of the signal to be detected decreases, degrading the accuracy. Incidentally, when in the optical disk drive a request for recording or reproducing information is not sent from a host apparatus for a predetermined time or more, the focus control and tracking control are stopped, bringing the drive into a status called a sleep in which the rotation of the disk is stopped to thereby minimize power consumption in the drive. At the time the rotational speed of the motor lowers on the excursion to the sleep status or mode, the FG signal cannot be outputted correctly, causing a problem that the surface vibration and eccentricity components memorized synchronously with the disk rotation and the focus jump timing as well do not coincide with the actual disk rotational phase.

Consequently, there arises a problem that when a request for recording or reproducing information is sent from the host after the sleep and the optical disk drive again operates to rotate the disk so as to perform the focus control and tracking control, the operation of the drive becomes unstable if the surface vibration and eccentricity components which have been memorized before the sleep and the previously determined focus jump timing are used. Further, a new problem is encountered in which if surface vibration and eccentricity components are again memorized or the focus jump timing is again determined after the sleep to avoid the aforementioned inconvenience, operation to respond to a request for recording or reproducing information from the host is delayed.

It is an object of the present invention to quickly respond to a request for recording or reproducing information from a host when focus control and tracking control are carried out by causing a disk to restart rotating from a sleep mode.

The object of the invention can be accomplished by, for example, also using learning values before a sleep process when the apparatus recovers from the sleep mode.

According to the present invention, a request for recording or reproducing information from the host can be responded quickly when carrying out the focus control and tracking control by causing the disk to again rotate from the sleep mode.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing construction of an optical disk drive according to a first embodiment of the invention.

FIG. 2 is a diagram showing the relation between a BCA region on an optical disk and addresses outputted from an address generator.

FIG. 3 is a time chart showing how a BCA decode signal is related to addresses outputted from the address generator.

FIG. 4 is a flowchart for explaining surface vibration component and eccentricity component memorizing process to be carried out before sleep.

FIG. 5 is a flowchart for explaining a sleep process.

FIG. 6 is a flowchart for explaining surface vibration component and eccentricity component memorizing process to be carried out after the sleep.

FIG. 7 is a block diagram showing construction of an optical disk drive according to a second embodiment of the invention.

FIGS. 8A and 8B are time charts showing how a BCA decode signal, addresses outputted from an address generator and data are related to one another in the second embodiment.

FIG. 9 is a flowchart for explaining a surface vibration component and eccentricity component memorizing process to be carried out before sleep in the second embodiment.

FIG. 10 is a flowchart for explaining a surface vibration component and eccentricity component memorizing process to be carried out after the sleep in the second embodiment.

FIG. 11 is a block diagram showing construction of an optical disk drive according to a third embodiment of the invention.

FIG. 12 is a diagram showing the relation between a rotation synchronization mark and addresses outputted from the address generator.

FIG. 13 is a time chart showing the relation between a rotation synchronization mark signal and addresses outputted from the address generator.

FIG. 14 is a flowchart for explaining a surface vibration component and eccentricity component memorizing process to be carried out before sleep in the third embodiment.

FIG. 15 is a flowchart for explaining a surface vibration and eccentricity component memorizing process to be carried out after the sleep in the third embodiment.

FIG. 16 is a diagram showing a configuration of a rotation synchronization mark 39 and a rotation synchronization mark detector 40.

FIG. 17 is a block diagram showing construction of an optical disk drive according to a fourth embodiment of the invention.

FIGS. 18A and 18B are time charts each showing the relation between a rotation synchronization pulse and addresses outputted from the address generator in the fourth embodiment.

FIG. 19 is a flowchart for explaining a surface vibration component and eccentricity component memorizing process to be carried out before sleep in the fourth embodiment.

FIG. 20 is a flowchart for explaining a surface vibration and eccentricity component memorizing process to be carried out after the sleep in the fourth embodiment.

### DETAILED DESCRIPTION OF THE EMBODIMENTS

Embodiments of the present invention will now be described in greater detail with reference to the accompanying drawings.

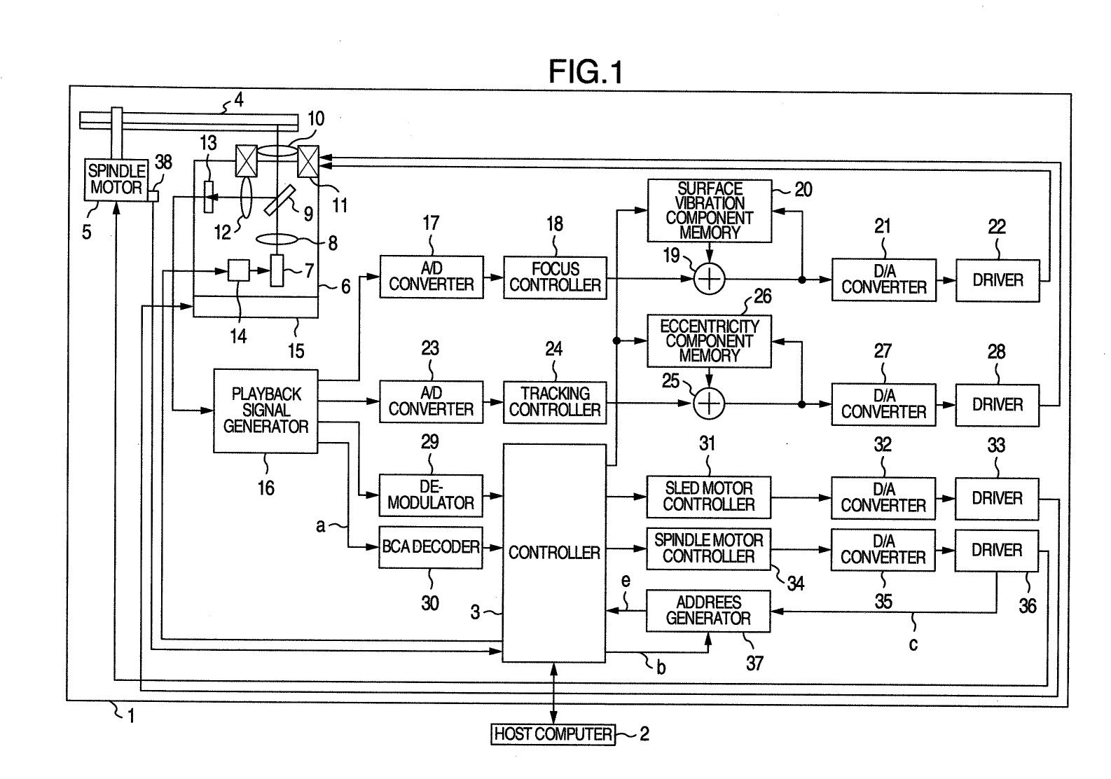

Referring to FIG. 1, an optical disk drive according to a first embodiment is designated generally by reference numeral 1. The optical disk drive 1 is so constructed as to respond to a request from a host computer 2 to reproduce data recorded on an optical disk 4 or to record data.

In the case of the optical disk drive 1, various commands transmitted from the host computer 2 are supplied to a controller 3. The controller 3 is comprised of a microcomputer having a CPU (Central Processing Unit) and an internal memory stored with various control programs and it carries out necessary control processes and operation processes on the basis of commands fed from the host computer 2 and various kinds of information fed from various kinds of circuits inside the optical disk drive 1.

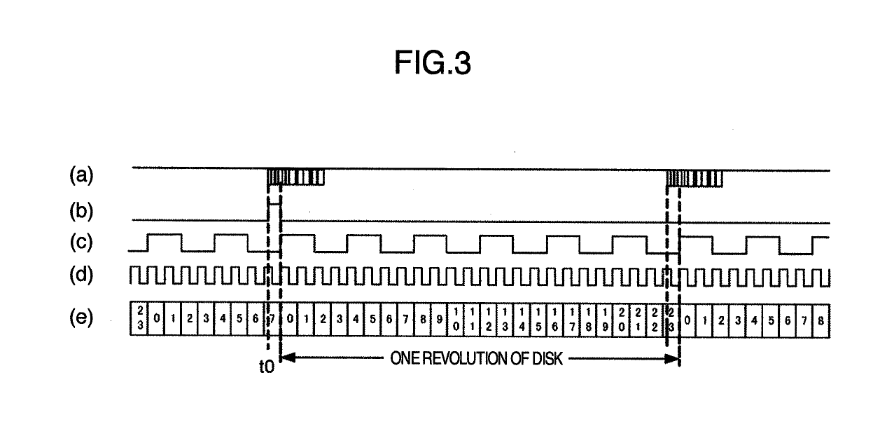

For example, when a reproduction command is fed from the host computer 2, the controller 3 designates to a spindle motor controller 34 a given rotational speed complying with the kind of the optical disk 4. The spindle motor controller 34 outputs to a D/A converter 35 a control signal necessary for rotating a spindle motor 5 at the designated rotational speed on the basis of a signal reproduced from the optical disk 4 or an FG signal delivered out of a spindle motor driver 36. An output of the D/A converter 35 is inputted to the spindle motor driver 36, so that the spindle motor 5 is driven to rotate the optical disk 4. The spindle motor driver 36 has the function to detect a rotation angle with the help of, for example, a Hall sensor provided for the spindle motor 5 and each time that the spindle motor 5 rotates through a given angle, it generates a pulse which in turn is outputted in the form of a FG (Frequency Generator) signal to an address generator 37. The address generator 37 has the function to multiply pulses of the inputted FG signal so that when, for example, 6 pulses of FG signal per revolution of spindle motor 5 are outputted as shown at (c) in FIG. 3, a signal of 4×6 pulses may be generated as shown at (d) in FIG. 3 and on the basis of these pulses, addresses of 0 to 23 may be generated at a period of one revolution of the disk as shown at (e) in FIG. 3.

The controller 3 also designates to a laser driver 14 carried on an optical pickup 6 a given laser output complying with the kind of the optical disk 4. Thus, a laser beam of given power is emitted from a laser 7 and is then focused on a recording surface of the optical disk 4 through the medium of a collimator lens 8, a half mirror 9 and an objective lens 10. Rays reflected from the optical disk 4 pass through the objective lens 10, reflected by the half mirror 9 and converged on a photodetector 13 via a condenser lens 12, being converted into an electric signal eventually. An output of the photodetector 13 is inputted to a playback signal generator 16 which in turn generates a focus error signal for performing focus control, a tracking error signal for performing tracking control, an RF signal for reproducing data recorded on the optical disk 4 and a BCA signal for reproducing information inherent to the disk, recorded in a BCA (Burst Cutting Area) on the optical disk 4.

The focus error signal generated from the playback signal generator 16 is converted by means of an A/D converter 17 into a digital signal which in turn is inputted to a focus controller 18. In the focus controller 18, the phase and gain are compensated for stabilizing the control system and for reducing a focus follow-up error to a predetermined value or less. An output of the focus controller 18 is added by an adder 19 to an output of a surface vibration component memory 20, providing a resultant signal which is converted by a D/A converter 21 into an analog focus drive signal to be inputted to a focus driver 22. The controller 3 operates, on the basis of the addresses having the period of disk one revolution generated in the address generator 37, to cause the surface vibration component memory 20 to memorize surface vibration components generated synchronously with the rotation of optical disk 4. On the basis of the focus drive signal, the focus driver 22 drives an actuator 11, carried on the optical pickup 6, in a direction vertical to the disk plane. The objective lens 10 and actuator 11 are so constructed as to move integrally with each other, so that as the actuator 11 moves in the direction vertical to the optical disk 4, the objective lens 10 is also moved in the direction vertical to the optical disk 4 to enable focus control to be carried out in order for the laser beam to be focused on the recording surface of optical disk 4.

Similarly, the tracking error signal generated by the playback signal generator 16 is converted by an A/D converter 23 into a digital signal which in turn is inputted to a tracking controller 24. In the tracking controller 24, the phase and gain are compensated for stabilizing the control system and for reducing a tracking follow-up error to a predetermined value or less. An output of the tracking controller 24 is added by an adder 25 to an output of an eccentricity component memory 26, providing a resultant signal which is converted by a D/A converter 27 to an analog tracking drive signal to be inputted to a tracking driver 28. The controller 3 operates, on the basis of the addresses at the period of disk one revolution generated in the address generator 37, to cause the eccentricity component memory 26 to memorize track eccentricity components generated synchronously with the rotation of optical disk 4. On the basis of the tracking drive signal, the tracking driver 28 drives the actuator 11, carried on the optical pickup 6, in a radial direction of the optical disk 4. Since the objective lens 10 and actuator 11 are so constructed as to move integrally with each other, as the actuator 11 moves in the radial direction of the optical disk 4, the objective lens 10 is also moved in the radial direction of the optical disk 4 to enable tracking control to be carried out in order for the laser beam to follow up a track on the optical disk 4.

Then, the BCA signal generated by the playback signal generator 16 is inputted to a BCA decoder 30. The BCA on the optical disk 4 is formed in a bar-code pattern at an inner peripheral part and in order to obtain a BCA signal from the BCA region, the optical pickup 6 needs to be moved to a predetermined position on the optical disk 4 so as to permit the laser beam to be irradiated on the BCA region. A signal to be outputted from a sled motor controller 31 as the controller 3 designates to the sled motor controller 31 a moving direction and a moving amount is inputted to a sled motor driver 33 via a D/A converter 32, thus driving a slider motor 15. The optical pickup 6 is so constructed as to move in the radial direction of the disk by means of the slider motor 15 and so, with the slider motor 15 instructed by the controller 3 to move, the optical pickup 6 is moved in a designated radial direction of the optical disk 4 by a designated amount. The BCA decoder 30 reproduces information inherent to the disk from the inputted BCA signal and delivers it to the controller 3. The controller 3 performs a subsequent recording or reproduction process on the basis of the information obtainable from the BCA signal and inherent to the disk by indicating the kind of the disk and a recommended recording condition as well.

The playback signal generator 16 also outputs an RF signal necessary to reproduce data recorded on the optical disk 4 to a demodulator 29 and reproduced data is inputted to the controller 3. Responsive to a request from the host computer 2, the controller 3 delivers the reproduced data to the host computer 2.

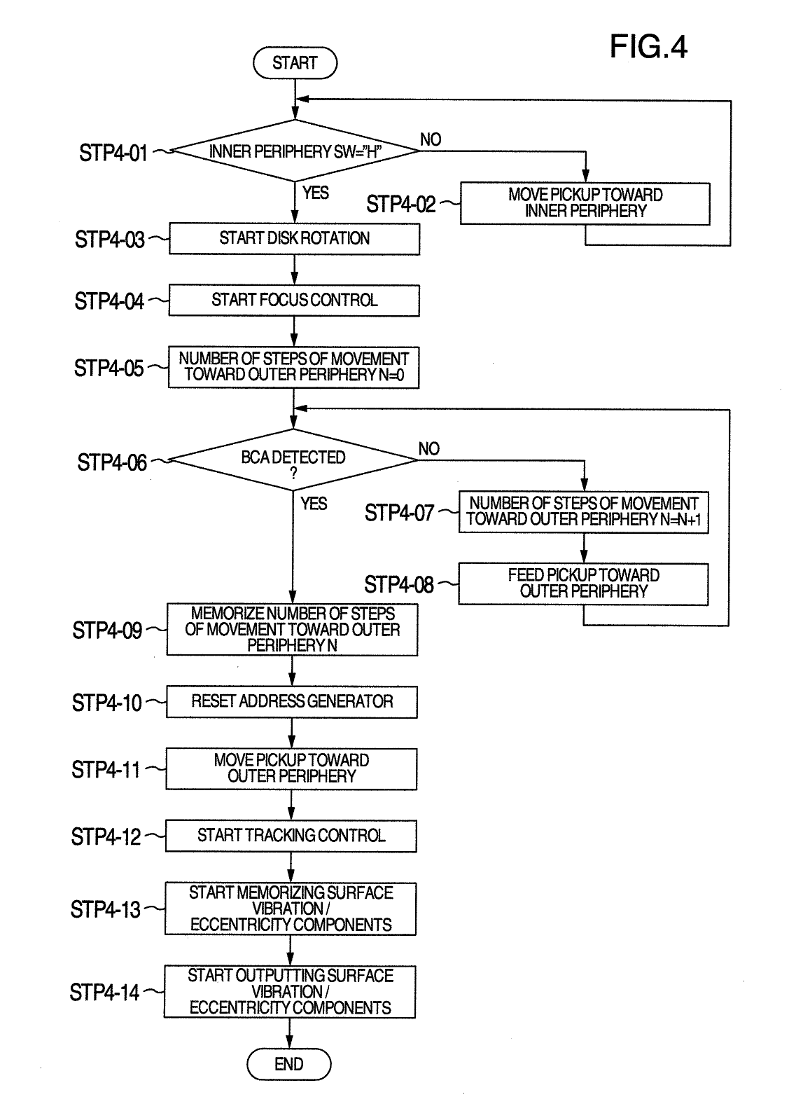

Next, surface vibration component and eccentricity component memorizing operation will now be described by using a timing chart of FIG. 3 and flowcharts of FIGS. 4, 5 and 6.

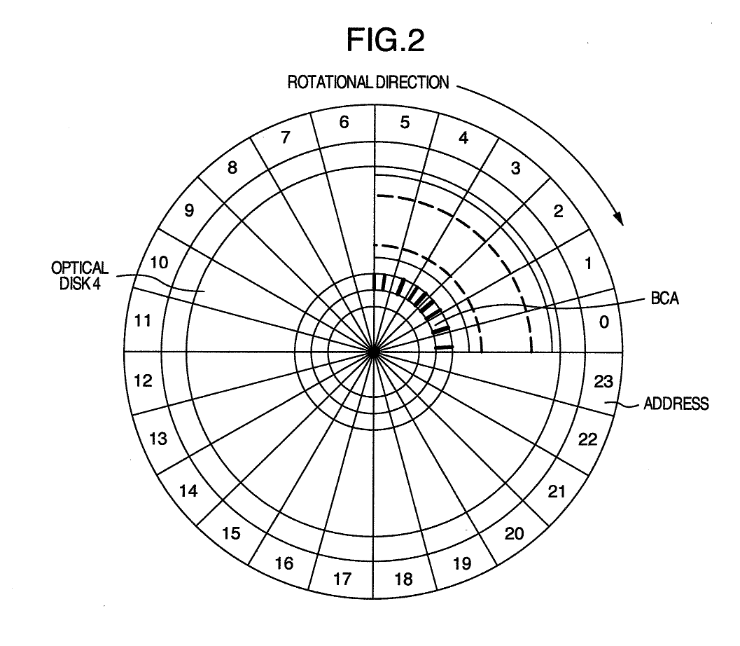

In FIG. 4, when the optical disk 4 is mounted to the optical disk drive 1 in a predetermined condition, the controller 3 confirms an output of an inner position switch (sensor) 38 (STP4-01) and if the output is “L” (“NO” being issued from the decision step STP4-01), instructs the sled motor controller 31 to move the optical pickup 6 by a given amount toward an inner periphery (STP4-02). After the optical pickup 6 has moved by the given amount, the controller 3 again confirms an output of the inner position switch (sensor) 38 (STP4-01) while repeating the processes of STP4-01 and STP4-02 until the output of the inner position switch (sensor) 38 assumes “H” (“YES” being issued from the decision step STP4-01). At the time that the output of the inner position switch (sensor) 38 exhibits “H” and the optical pickup 6 has moved to the predetermined position, the controller 3 instructs the spindle motor controller 34 to rotate the spindle motor 5 at a given rotational speed (STP4-03). On the basis of a FG signal outputted from the spindle motor driver 36, the spindle motor controller 34 outputs to the D/A converter 35 a control signal for causing the spindle motor 5 to rotate at the designated rotational speed. Next, the controller 3 instructs the focus controller 18 to start focus control and the focus control is carried out such that the laser beam is focused on the recording surface of optical disk 4 (STP4-04). Next, in order to determine an amount of movement to the BCA region from a position at which the output of inner position switch (sensor) 38 is “H”, the number N of moving steps toward an outer periphery (hereinafter simply referred to as outer periphery moving step number N) is set to 0 (zero) (STP4-05). Then, a signal inputted from the BCA decoder 30 to the controller 3 is confirmed and if a BCA decode signal is not detected (“NO” from decision step STP4-06), the outer periphery moving step number N is incremented by 1 (STP4-07) and the sled motor controller 31 is instructed to cause the optical pickup 6 to move by a given amount toward the outer periphery (STP4-08). After the optical pickup 6 has been moved by the given amount, the output of BCA decoder 30 is again confirmed (STP4-06) and the processes of STP4-06 to STP4-08 are repeated until a BCA decode signal can be detected (“YES” is issued from the decision step STP4-06). When the movement of the optical pickup 6 to the BCA region is completed, a BCA decode signal corresponding to the BCA formed in a bar-code pattern as shown at (a) in FIG. 3 is outputted from the playback signal generator 16. The BCA decoder 30 reproduces information inherent to the disk from the BCA signal and outputs the information to the controller 3. From the output of the BCA decoder 30, the controller 3 determines that the BCA decode signal is detected (in the decision step STP4-06, “YES”) and then, memorizes the outer periphery moving step number N as the moving amount from the position where the output of inner positioning detection switch 38 is “H” to the BCA region (STP4-09). Further, as shown in FIG. 3, a reset signal at (b) in FIG. 3 is outputted to the address generator 37 at time t0 that the BCA decode signal is detected (STP4-10). The address signal at (e) in FIG. 3 is reset to 0 at the time of inputting the reset signal at (b) and addresses which have a period of one revolution of disk and correspond to phases of rotation of the optical disk 4 as shown in FIG. 2 are generated. Next, the sled motor controller 31 is instructed by the controller 3 to move the optical pickup 6 by a given amount toward an outer periphery from the BCA region (STP4-11), the controller 3 instructs the tracking controller 24 to start tracking control (STP4-12) and the tracking control is carried out such that the laser beam follows up a track on the optical disk 4. Subsequently, the controller 3 instructs the surface vibration component memorizing circuit 20 and eccentricity component memorizing circuit 26 to start memorizing a surface vibration component and an eccentricity component, respectively, (STP4-13) and the surface vibration component and eccentricity component are memorized in accordance with the address signal at (e) in FIG. 3 inputted from address generator 37 to controller 3, which address signal has the period of disk one revolution and corresponds to the rotational phases of optical disk 4. After memorizing the surface vibration component and eccentricity component has been started, the optical disk 4 is rotated through at least one revolution, during which at the time that surface vibration components and eccentricity components for one disk revolution have been memorized, the controller 3 instructs the surface vibration component memory 20 and eccentricity component memory 26 to output the memorized surface vibration component and the eccentricity component to the adder 19 and adder 25, respectively (STP4-14). Through the process as above, the addresses outputted from the address generator 37 can be generated synchronously with the detection timing of BCA decode signal and the surface vibration and eccentricity components can be memorized at the revolution period of optical disk 4 in correspondence with the addresses while being updated.

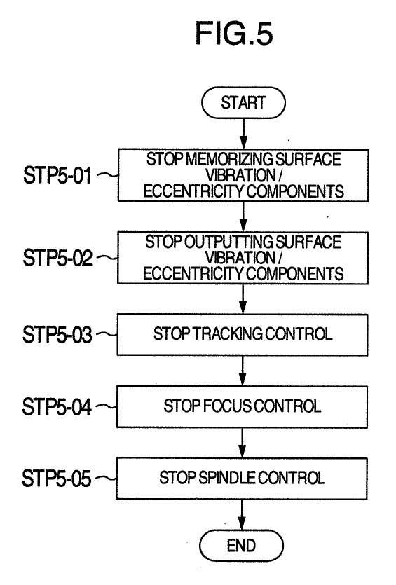

Next, a sleep process for stopping the rotation of the disk will be described with reference to FIG. 5.

In the sleep process, the controller 3 first instructs the surface vibration component memory 20 and eccentricity component memory 26 to stop updating the memorization of surface vibration and eccentricity components (STP5-01). Next, the controller 3 instructs the surface vibration component memory 20 and eccentricity component memory 26 to stop outputting surface vibration and eccentricity components (STP5-02). Subsequently, the controller 3 outputs to the tracking controller 24 a command to stop the tracking control (STP5-03), to the focus controller 18 a command to stop the focus control (STP5-04) and thereafter to the spindle motor controller 34 a command to stop the spindle control, thus stopping the rotation of optical disk 4 (STP-05). Through the above processes, while the surface vibration components and eccentricity components, with which the addresses outputted from the address generator 37 are synchronized, being kept memorized, the rotation of the disk is stopped.

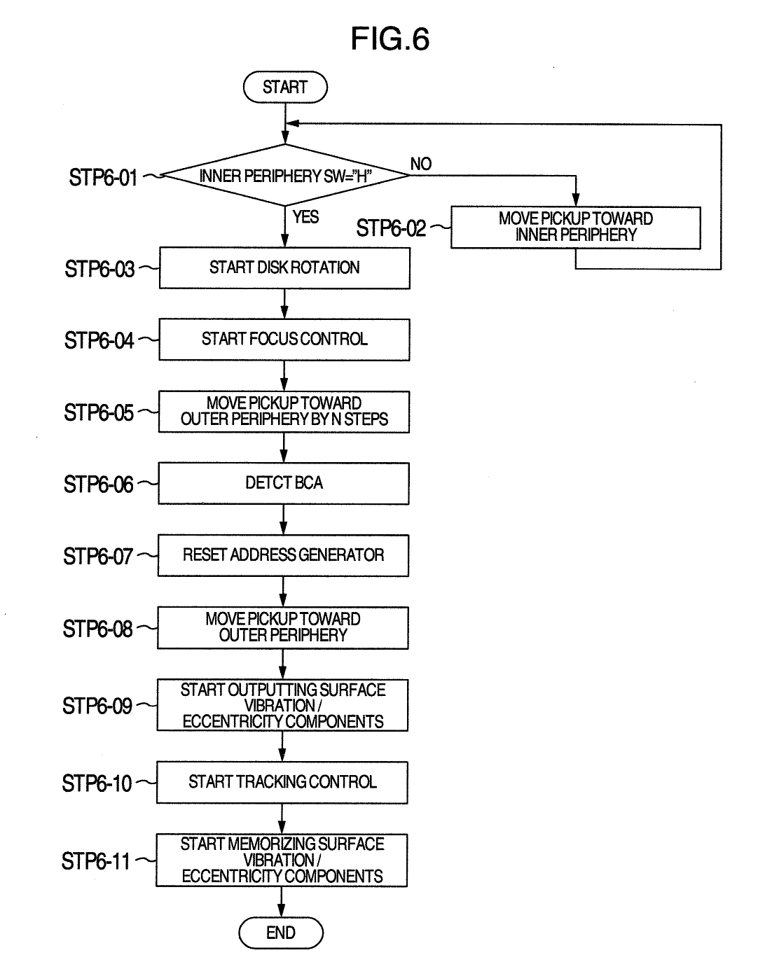

A process for recovery from the sleep will be described with reference to a flowchart of FIG. 6.

Firstly, the controller 3 confirms the output of the inner position switch (sensor) 38 (SFP6-01) and when the output is “L” (“NO” in the decision step STP6-01), it instructs the sled motor controller 31 to move the optical pickup 6 toward the inner periphery by a given amount (STP6-02). After the optical pickup 6 has moved by the predetermined amount, the output of inner position switch (sensor) 38 is again confirmed (STP6-01) and the processes of STP6-01 and STP6-02 are repeated until the output of the inner position switch (sensor) 38 assumes “H” (“YES” in the decision step STP6-01). At the time that the output of inner position switch (sensor) 38 exhibits “H” and the movement of optical pickup 6 to the predetermined position is completed, the controller 3 instructs the spindle motor controller 34 to cause the spindle motor 5 to rotate at a predetermined rotational speed (STP6-03). Here, in consideration of the frequency characteristics of actuator 11, it is preferable that the predetermined rotational speed substantially coincides with the rotational speed at the time that the surface vibration component memory 20 and eccentricity component memory 26 are instructed to stop updating the memorization of the surface vibration component and eccentricity component in the sleep process. In the spindle motor controller 34, it outputs, on the basis of the FG signal outputted from the spindle motor driver 36, to the D/A converter 35 a control signal for causing the spindle motor 5 to rotate at the designated rotational speed. Thereafter, the controller 3 instructs the focus controller 18 to start the focus control and the focus control is carried out such that the laser beam is focused on the recording surface of optical disk 4 (STP6-04). The sled motor controller 31 is instructed to move the optical pickup 6 toward the outer periphery by the stepping number N stored in the sled motor controller 31 in the previous STP4-09 (STP6-05). In this manner, the optical pickup 6 moves to the BCA region and the BCA decode signal as shown at (a) in FIG. 3 is outputted from the playback signal generator 16. The BCA decoder 30 reproduces information inherent to the disk from the BCA signal and outputs the information to the controller 3 (STP6-06). Further, as shown in FIG. 3, a reset signal (b) is outputted to the address generator 37 at time t0 that the BCA decode signal is detected (STP6-07). The address signal (e) to be outputted from the address generator 37 is reset at the time that the reset signal (b) is inputted, so that addresses are generated as shown in FIG. 2 which have the period of one revolution of the disk and correspond to the rotation phases of optical disk 4. Next, the controller 3 instructs the sled motor controller 31 to move the optical pickup 6 from the BCA region toward the outer periphery by a given amount (STP6-08) and then the controller 3 instructs the surface vibration component memory 20 and eccentricity component memory 26 to output the memorized surface vibration component and eccentricity component to the adder 19 and adder 25, respectively (STP6-09). In each of the steps STP4-10 and STP6-07, the reset signal (b) is outputted to the address generator 37 at the time t0 that the BCA decode signal is detected and therefore, the address signal delivered out of the address generator 37 is updated at the same timing, starting from the time point t0 of detection of the BCA decode signal. In this manner, the surface vibration component and eccentricity component are outputted, which have been memorized in the surface vibration component memory 20 and eccentricity component memory 26 under the condition that before the sleep, the timing for detection of BCA decode signal is synchronized with the addresses outputted from the address generator 37 and corresponding to the rotation phase of the optical disk 4. Subsequently, the controller 3 instructs the tracking controller 24 to start the tracking control (STP6-10) and the tracking control is carried out such that the laser beam follows up a track on the optical disk 4. Next, the controller 3 instructs the surface vibration component memory 20 and eccentricity component memory 26 to start the memorization of the surface vibration component and eccentricity component (STP6-11) and the surface vibration component and eccentricity component are stored while being updated in accordance with the address signal (e) of disk one revolution period inputted from the address generator 37 to the controller 3.

In the foregoing embodiment, as shown in FIGS. 2 and 3, the address signals outputted from the address generator 37 before and after the sleep are updated at the same timing, starting from the time t0 that the BCA decode signal is detected. This can ensure that the relation between the rotation phase and the address can remains unchanged after and before the sleep and therefore even when the surface vibration component and eccentricity component memorized before the sleep are outputted after the sleep, the focus control and tracking control never become unstable. In addition, since the tracking control is started with the eccentricity corrected after the sleep, the tracking control can start stably. Further, because of the fact that the outer periphery moving step number N has been memorized before the sleep as the moving amount to the BCA region from the position at which the output of the inner position switch (sensor) 38 assumes “H” and that the movement to the BCA region is achieved after the sleep by using the memorized outer periphery moving step number N, the time for the process for movement to the BCA region after the sleep can be shortened.

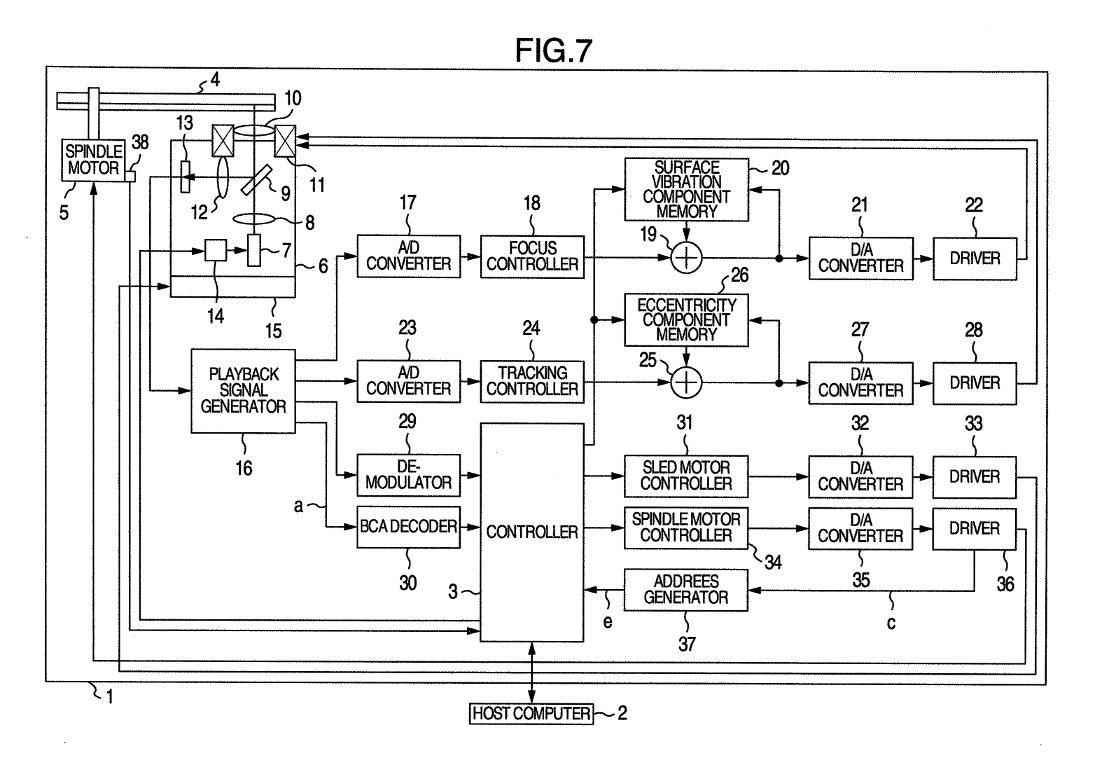

Referring now to a block diagram of FIG. 7, a second embodiment of the invention will be described. In FIG. 7, elements and signals designated by the same reference numerals as those in FIG. 1 are the same elements as those in FIG. 1 and the same signals as those acting similarly in FIG. 1. The second embodiment in FIG. 7 differs from the first embodiment in FIG. 1 in that the signal for resetting is not inputted from the controller 3 to the address generator 37.

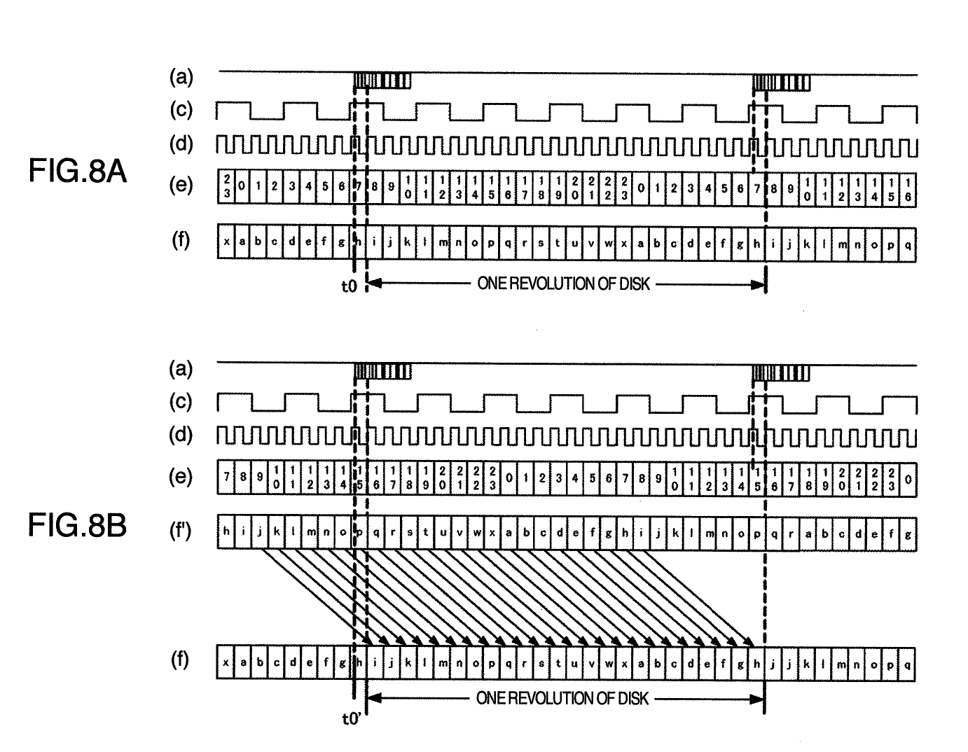

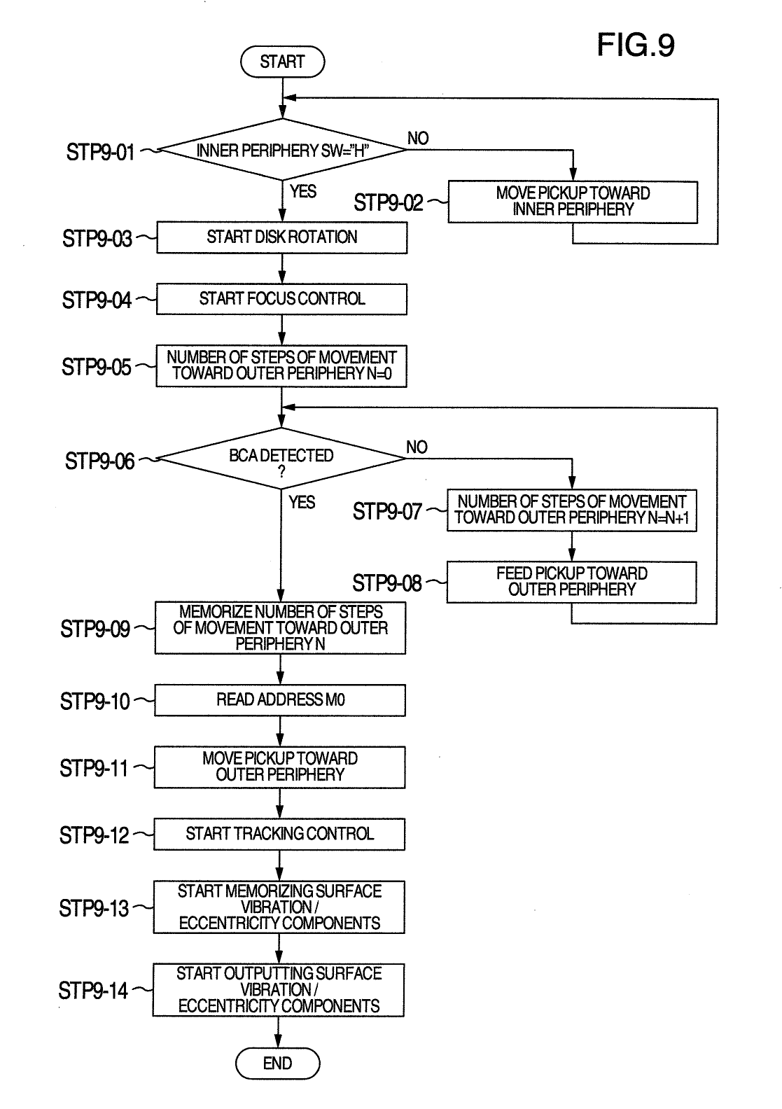

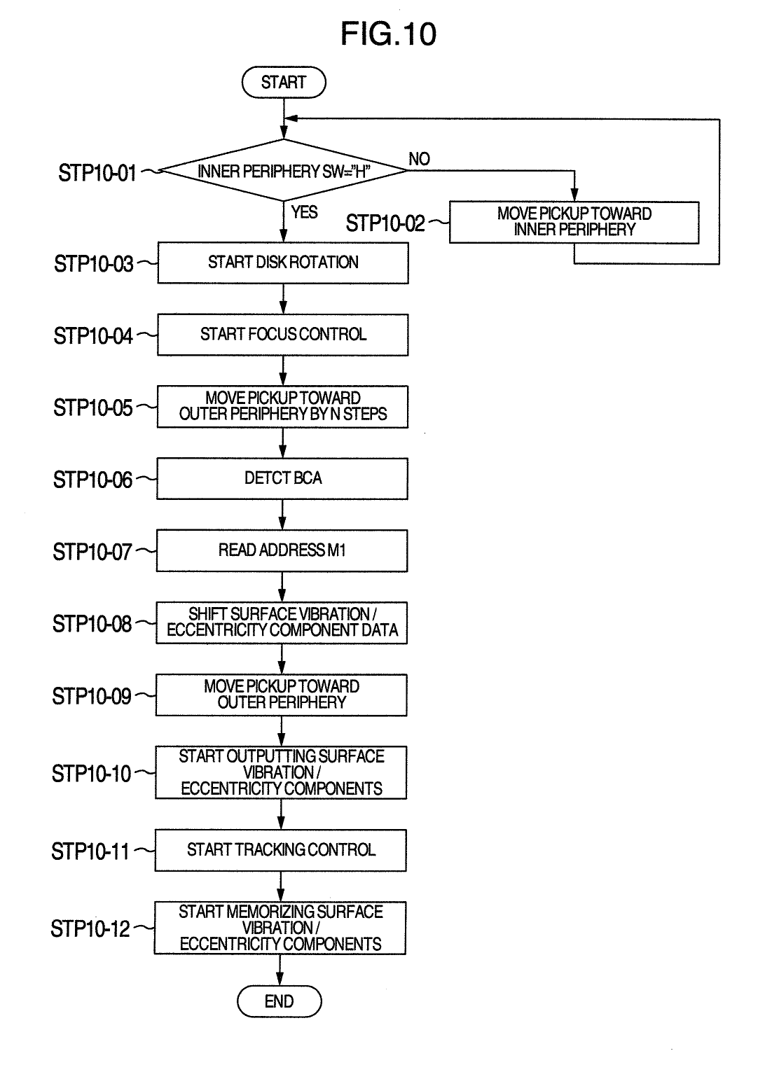

Surface vibration component and eccentricity component memorizing operation in the FIG. 7 embodiment will be described by using timing charts of FIGS. 8A and 8B and flowcharts of FIGS. 9 and 10.

In FIG. 9, processes of DTP9-01 to STP9-09 are identical to those of STP4-01 to STP4-09 in FIG. 4. In STP9-10, an address M0 at time t0 at which a BCA decode signal is detected from an address signal inputted from the address generator 37 (in this example, M0=7) is read as shown in FIG. 8A. In ensuing steps STP9-11 to STP9-14, the same processes as those in STP4-11 to STP4-14 in FIG. 4 are carried out, so that surface vibration component and eccentricity component are memorized while being updated in accordance with the address signal (e) of disk one revolution period inputted to the controller 3 from the address generator 37. The sleep process for stopping the rotation of disk is the same as that in FIG. 5 and will not be described herein.

Turning to FIG. 10, there is illustrated a flowchart showing a process for recovery from the sleep. In FIG. 10, processes of STP10-01 to STP10-06 are identical to those of STP6-01 to STP6-06 in FIG. 6. In designating a disk rotational speed in STP10-03, it is preferable that in consideration of the frequency characteristics of the actuator 11, the rotational speed is substantially the same as that at the time that update of memorization of surface vibration component and eccentricity component is stopped when the surface vibration component memory 20 and eccentricity component memory 26 are so instructed. In STP10-07, an address M1 at the time point t0 at which a BCA decode signal is detected from the address signal inputted from the address generator 37 (in this example, M1=15) is read as shown in FIG. 8B. From a difference between the address M1 and the address M0 which has been read before the sleep, the difference in address between the rotation phase of optical disk 4 before the sleep and that after the sleep is detected and then, data of surface vibration component and eccentricity component ((f′) in FIG. 8B) which have been stored after the sleep in the surface vibration component memory 20 and eccentricity component memory 26 in accordance with the address signal (e) are shifted to obtain data shown at (f)in FIG. 8B. For example, data stored at the address M1 (in this example M1=15) at the BCA signal detection time t0 after the sleep (in this example, “p”) is rewritten to data stored at the address M0 (in this example, M0=7) at the BCA signal detection time t0 before the sleep (in this example, “h”). In this manner, the data of surface vibration component and eccentricity component corresponding to the rotation phase of optical disk 4 after the sleep ((f′) in FIG. 8B) can coincide with the data before the sleep ((f) in FIG. 8A). Thereafter, processes of STP10-9 to STP10-12 identical to those of STP6-08 to STP6-11 in FIG. 4 are carried out so that the surface vibration component and eccentricity component may be memorized while being updated in accordance with the address signal (e) of disk one revolution period inputted from the address generator 37 to the controller 3.

In the second embodiment, by shifting the data stored in the surface vibration component memory 20 and eccentricity component memory 26 without resetting the address generator 37, advantages similar to those in the first embodiment can be attained.

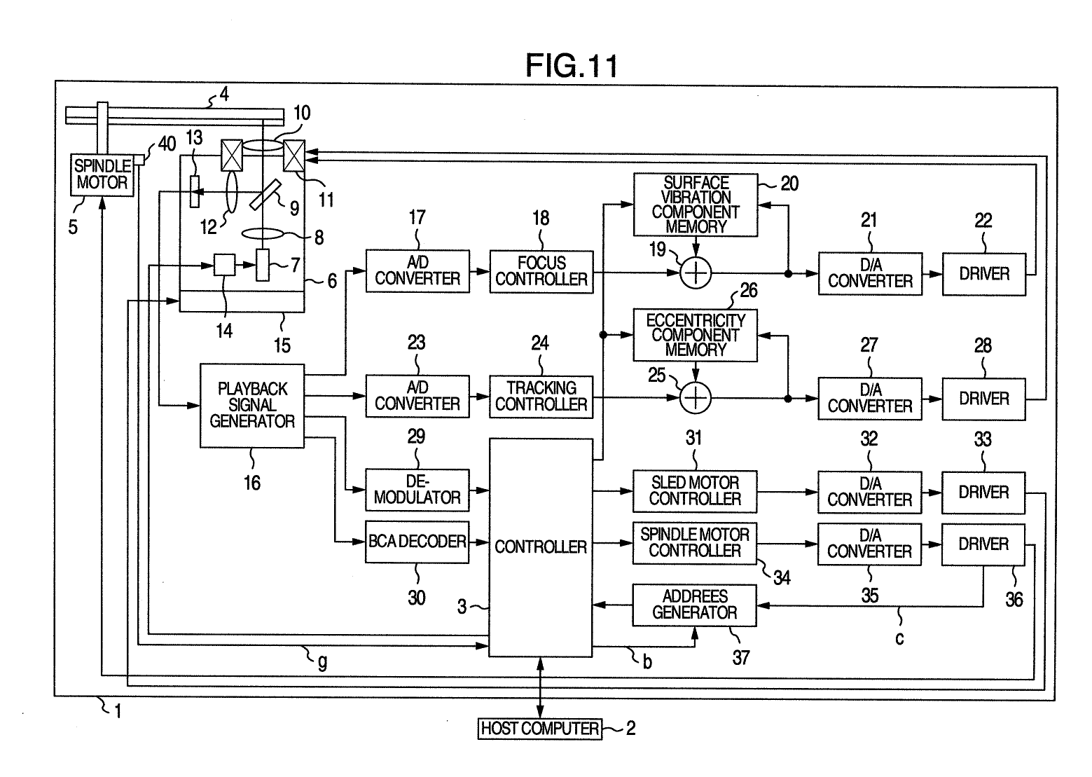

Referring now to a block diagram of FIG. 11, a third embodiment of the invention will be described. In FIG. 11, elements and signals designated by the same reference numerals as those in FIG. 1 are the same elements as those in FIG. 1 and the same signals as those acting similarly in FIG. 1. The third embodiment in FIG. 11 differs from the first embodiment in FIG. 1 in that a rotation synchronization mark detector 40 for detecting a rotation synchronization mark 39 formed on an inner periphery on the optical disk 4 is provided.

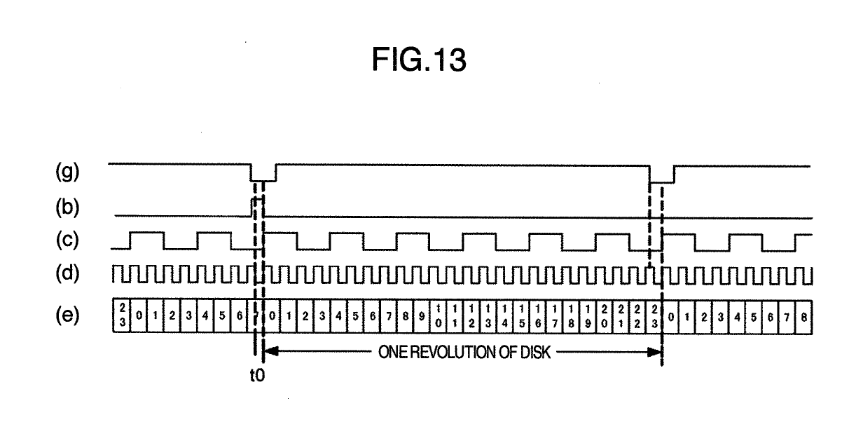

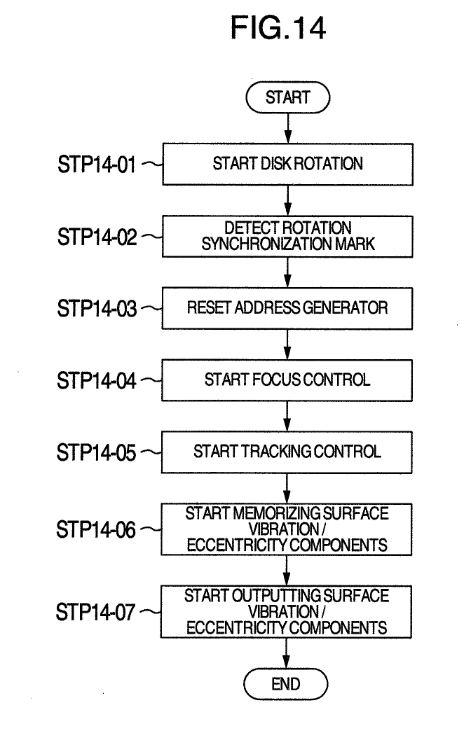

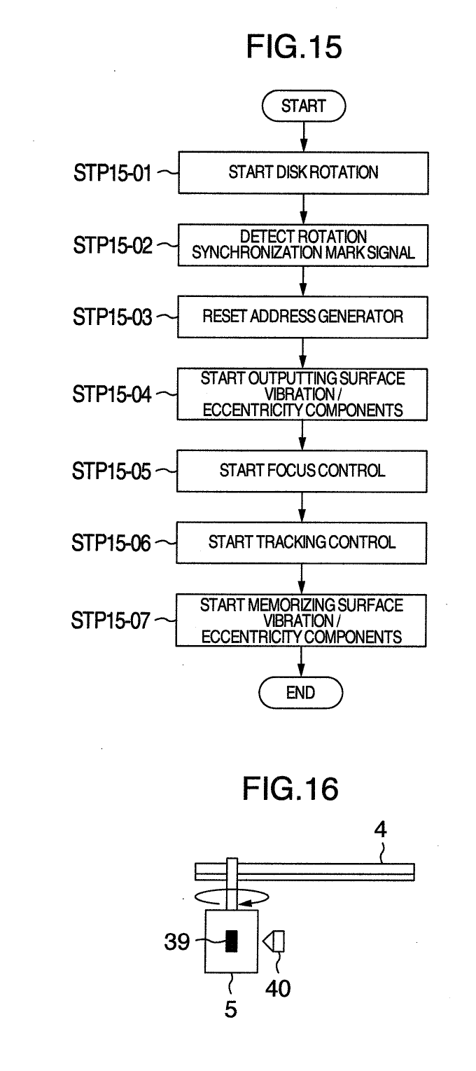

Surface vibration component and eccentricity component memorizing operation in the FIG. 11 embodiment will be described by using a timing chart of FIG. 13, and flowcharts of FIGS. 14 and 15.

In FIG. 14, when the optical disk 4 is mounted to the optical disk drive 1 in a predetermined condition, the controller 3 instructs the spindle motor controller 34 to rotate the spindle motor 5 at a given rotational speed (STP14-01). On the basis of a FR signal outputted from the spindle motor driver 36, the spindle motor controller 34 outputs to the D/A converter 35 a control signal necessary for rotating the spindle motor 5 at the designated rotational speed. Next, the controller 3 monitors a timing at which a rotation synchronization mark signal (g) outputted from the rotation synchronization mark detector 40 changes its level from “H” to “L” and detects the rotation synchronization mark (STP14-02), delivering a reset signal (b) to the address generator 37 (STP14-03). The address generator 37 multiplies a FG signal (c) of 6 pulses per revolution outputted from the spindle motor driver 37 by four to generate a pulse (d) and, on the basis of this pulse, outputs an address signal (e). The address signal (e) is reset at the time that the reset signal (b) is inputted and addresses having a period of one revolution of the disk and corresponding to rotation phases are generated. Subsequently, the controller 3 instructs the focus controller 18 to start focus control (STP14-04) and also instructs the tracking controller 24 to start tracking control (STP14-05), so that the focus control and tracking control are carried out such that the laser beam focuses on the recording surface of optical disk 4 and follows up a track. Next, the controller 3 instructs the surface vibration component memory 20 and eccentricity component memory 26 to start storing surface vibration component and eccentricity component (STP14-06) and in accordance with the address signal (e) of disk one revolution period inputted from the address generator 37 to the controller 3 and corresponding to the rotation phase of optical disk 4, the surface vibration component and eccentricity component are memorized. After the surface vibration component and eccentricity component have been memorized, the optical disk 4 is rotated through at least one revolution, during which at the time that surface vibration component and eccentricity component for one revolution of disk have been memorized, the controller 3 instructs the surface vibration component memory 20 and eccentricity component memory 26 to output the memorized surface vibration component and the eccentricity component to the adder 19 and adder 25, respectively (STP14-07). Through the above process, the rotation synchronization mark detection timing and the address to be outputted from the address generator 37 can be generated synchronously with each other as shown in FIG. 13 and the surface vibration and eccentricity components can be memorized at the revolution period of optical disk 4 in correspondence with the addresses while being updated. The sleep process for stopping the rotation of disk is the same as that in FIG. 5 and will not be described herein.

A process for recovery from the sleep will be described with reference to a flowchart of FIG. 15.

Processes of STP15-01 to STP15-03 in FIG. 15 are the same as those of STP14-01 to STP14-03 in FIG. 14. Firstly, the controller 3 instructs the spindle motor controller 34 to rotate the spindle motor 5 at a predetermined rotational speed (STP15-01). Here, in consideration of the frequency characteristics of the actuator 11, it is preferable that the predetermined rotational speed substantially coincides with a rotational speed at the time that the surface vibration component memory 20 and eccentricity component memory 26 are instructed to stop updating the memorization of the surface vibration and eccentricity components in the sleep process. Next, the controller 3 monitors the timing t0 at which the rotation synchronization mark signal (g) outputted from the rotation synchronization mark detector 40 changes its level from “H” to “L” to detect the rotation synchronization mark (STP15-02) and then outputs a reset signal (b) to the address generator 37 (STP15-03). The address signal (e) is reset to 0 at the time that the reset signal (b) is inputted and as shown in FIG. 13, addresses having a period of disk one revolution and corresponding to rotation phases of the optical disk 4 are generated. Subsequently, the controller 3 instructs the surface vibration component memory 20 and eccentricity component memory 26 to deliver the stored surface vibration component and eccentricity component to the adder 19 and adder 25, respectively (STP15-04). Since, in each of the steps STP14-03 and STP15-03, the reset signal (b) is delivered to the address generator 37 at the time t0 that the rotation synchronization mark 39 is detected, the address signal outputted from the address generator 37 is updated at the same timing, starting from the time t0 at which the rotation synchronization mark 39 is detected. In this manner, the surface vibration component and eccentricity component are outputted, which have been stored before the sleep in the surface vibration component memory 20 and eccentricity component memory 25 at the rotation synchronization mark detection timing and under the condition that the corresponding address outputted from the address generator 37 is synchronous with the rotation phase of optical disk 4. Subsequently, the controller 3 instructs the focus controller 18 to start focus control (STP15-05) and also instructs the tracking controller 24 to start tracking control (STP15-06), so that the focus control and tracking control are carried out such that the laser beam focuses on the recording surface of optical disk 4 and follows up a track. Next, the controller 3 instructs the surface vibration component memory 20 and eccentricity component memory 26 to start memorizing the surface vibration component and eccentricity component (STP15-07), so that in accordance with the address signal (e) at the period of disk one revolution inputted from the address generator 37 to the controller 3, the surface vibration component and eccentricity component are memorized while being updated.

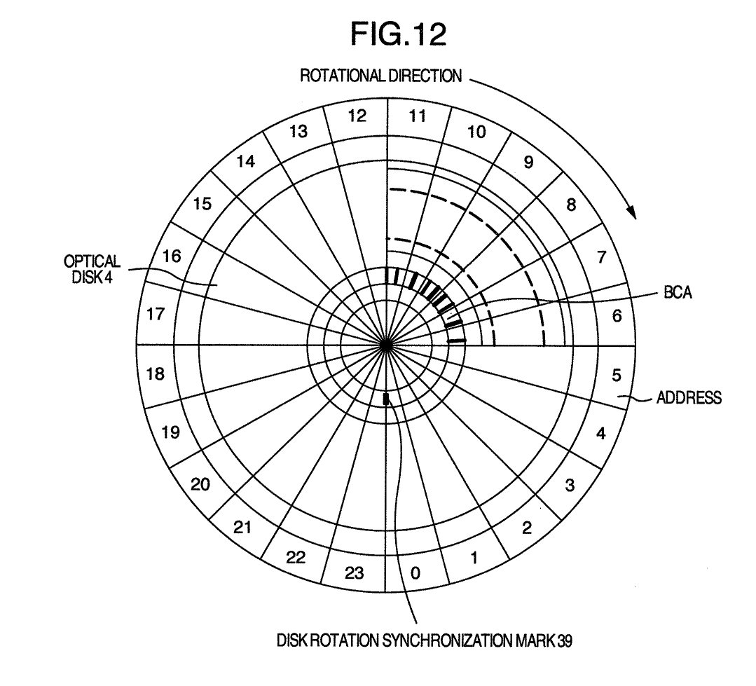

In the third embodiment, as shown in FIGS. 12 and 13, the address signal (e) outputted from the address generator 37 are updated before and after the sleep at the same timing, starting from the time t0 at which the rotation synchronization mark 39 is detected. Through this, the relation between rotation phase and address remains unchanged before and after the sleep and therefore, even when the surface vibration component and eccentricity component memorized before the sleep are outputted after the sleep, the focus control and tracking control never become unstable. Further, since the focus control and tracking control are started with the surface vibration and eccentricity corrected after the sleep, the focus control and tracking control can be started stably.

While in the present embodiment the rotation synchronization mark 39 is formed on the optical disk 4 and is detected by means of the rotation synchronization mark detector 40, this is not limitative and a non-contact type IC such as an RFID may be embedded in the optical disk and an RFID read circuit may be provided to obtain a signal synchronous with the rotation.

Further, a mark may be formed as the rotation synchronization mark 39 on a rotary part of spindle motor 5, for example, the rotor as shown in FIG. 16 and a rotation synchronization mark detector 40 for detecting the mark may be provided. For example, either a black seal having a low reflection factor or a seal such as made of aluminum foil and having a high reflection factor is bonded to the rotor and as the rotation synchronization mark detector 40, a photo-sensor having an integral LED and light-receiving element may be used, for instance. In the method as above, the rotation synchronization mark formed on the spindle motor is used, which method can therefore be applicable also to an optical disk devoid of the BCA region or rotation synchronization mark.

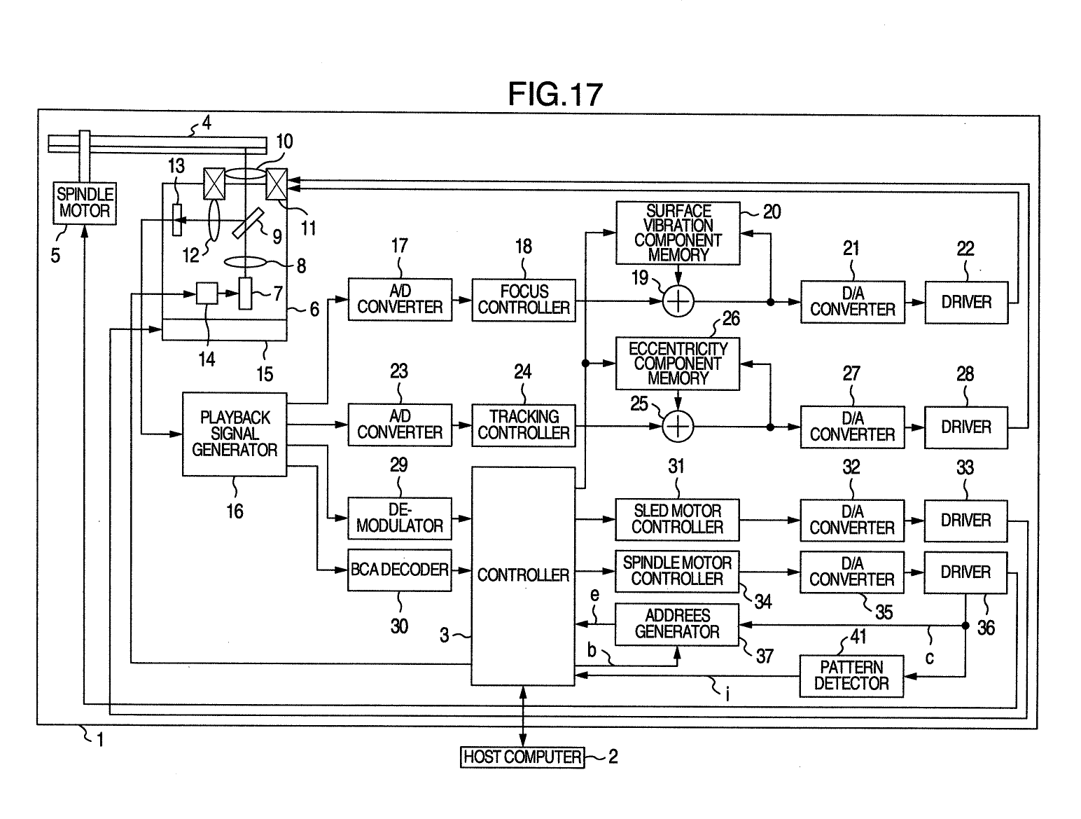

Referring now to a block diagram of FIG. 17, a fourth embodiment of the invention will be described. In FIG. 17, elements and signals designated by the same reference numerals as those in FIG. 1 are the same elements as those in FIG. 1 and the same signals as those acting similarly in FIG. 1. The fourth embodiment in FIG. 17 differs from the first embodiment in FIG. 1 in that a FG pattern detector 41 is provided which outputs a single rotation synchronization pulse per revolution of the optical disk from a time width pattern of FG signal delivered out of the spindle motor driver 36. For example, when generating a FG signal by detecting a rotation angle of the motor by means of a Hall sensor provided for the spindle motor 5, a rotation synchronization pulse can be generated by utilizing the fact that the period of the FG signal becomes irregular due to unevenness in mounting position of the Hall sensor.

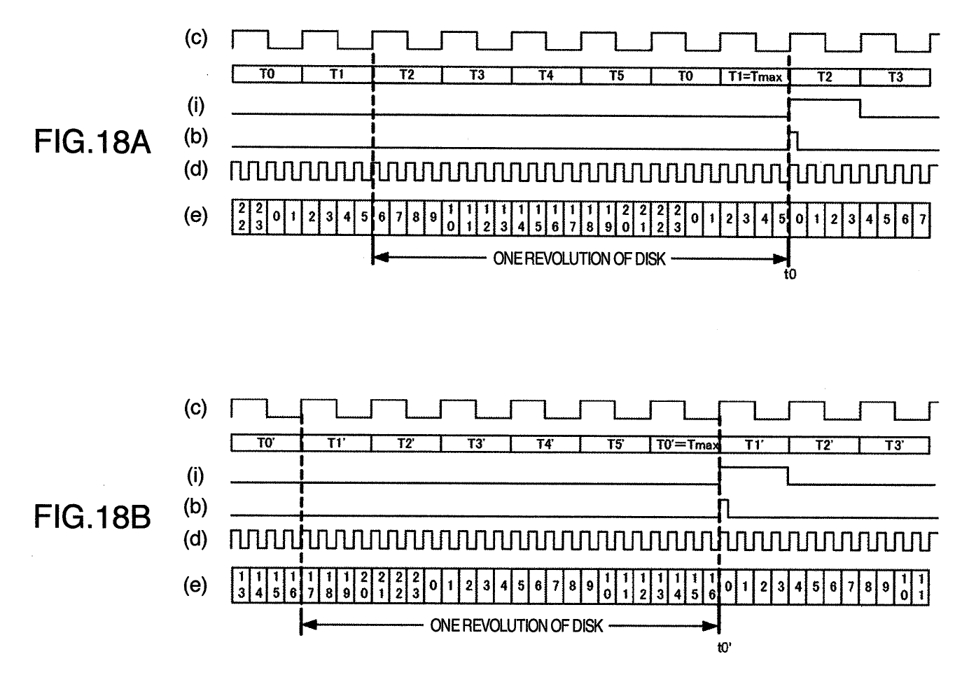

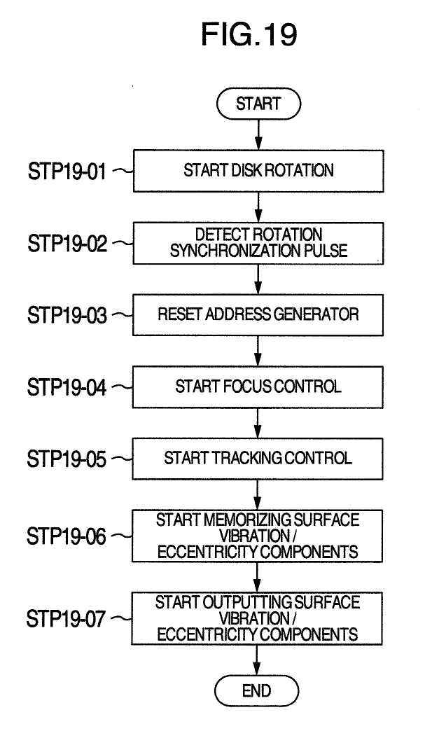

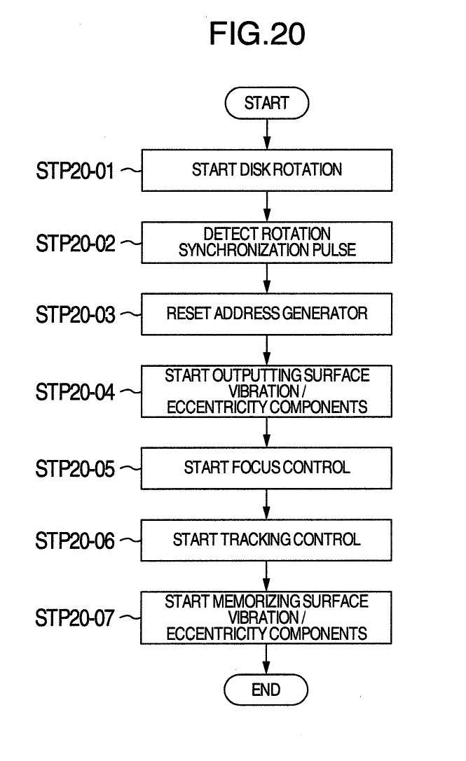

Surface vibration component and eccentricity component memorizing operation in the FIG. 17 embodiment will be described by using timing charts of FIGS. 18A and 18B, and flowcharts of FIGS. 19 and 20.

In FIG. 19, when the optical disk 4 is mounted to the optical disk drive 1 in a predetermined condition, the controller 3 instructs the spindle motor controller 34 to rotate the spindle motor 5 at a given rotational speed (STP19-01). On the basis of a FG signal outputted from the spindle motor driver 36, the spindle motor controller 34 outputs to the D/A converter 35 a control signal necessary for rotating the spindle motor 5 at the designated rotational speed. The FG pattern detection circuit 41 measures the period of a FG signal having 6 pulses outputted per revolution of the spindle motor 5, for example, as shown in FIG. 18A and outputs a rotation synchronization pulse (i) at time t0 immediately after detection of the longest period T1. The controller 3 monitors a timing at which the rotation synchronization pulse (i) changes its level from “L” to “H” and detects the rotation synchronization pulse outputted by one per revolution of the optical disk (STP19-02), delivering a reset signal (b) to the address generator 37 (STP19-03). The address generator 37 multiplies the FG signal (c) of 6 pulses per revolution outputted from the spindle motor driver 37 by four to generate a pulse (d) and, on the basis of this pulse, outputs an address signal (e). The address signal (e) is reset at the time that the reset signal (b) is inputted and addresses having a period of one disk revolution and corresponding to rotation phases of the optical disk 4 are generated. Subsequently, the controller 3 instructs the focus controller 18 to start focus control (STP19-04) and also instructs the tracking controller 24 to start tracking control (STP19-05), so that the focus control and tracking control are carried out such that the laser beam focuses on the recording surface of optical disk 4 and follows up a track. Next, the controller 3 instructs the surface vibration component memory 20 and eccentricity component memory 26 to start memorization of surface vibration component and eccentricity component (STP19-06) and in accordance with the address signal (e) of disk one revolution period inputted from the address generator 37 to the controller 3 and corresponding to the rotation phase of optical disk 4, the surface vibration component and eccentricity component are memorized. After the memorization of surface vibration component and eccentricity component has been started, the optical disk 4 is rotated through at least one revolution, during which at the time that surface vibration components and eccentricity components for one revolution of disk have been memorized, the controller 3 instructs the surface vibration component memory 20 and eccentricity component memory 26 to output the memorized surface vibration component and eccentricity component to the adder 19 and adder 25, respectively (STP19-07). Through the above process, the addresses to be outputted from the address generator 37 can be generated synchronously with the rotation synchronization pulse detection timing and the surface vibration and eccentricity components can be memorized at the revolution period of optical disk 4 in correspondence with the addresses while being updated. The sleep process for stopping the rotation of disk is the same as that in FIG. 5 and will not be described herein.

A process for recovery from the sleep will be described with reference to a flowchart of FIG. 20.

Processes of STP20-01 to STP20-03 in FIG. 20 are the same as those of STP19-01 to STP19-03 in FIG. 19. Firstly, the controller 3 instructs the spindle motor controller 34 to rotate the spindle motor 5 at a predetermined rotational speed (STP20-01). Here, in consideration of the frequency characteristics of the actuator 11, it is preferable that the predetermined rotational speed substantially coincides with a rotational speed at the time that the surface vibration component memory 20 and eccentricity component memory 26 are instructed to stop updating the memorization of the surface vibration and eccentricity components in the sleep process. The FG pattern detector 41 measures the period of a FG signal as shown in FIG. 18B and outputs a rotation synchronization pulse (i) at time t0′ immediately after detection of the longest period T0′. The controller 3 monitors a timing at which the rotation synchronization pulse (i) delivered out of the FG pattern detector 41 changes its level from “L” to “H” and detects the rotation synchronization pulse (STP20-02), delivering a reset signal (b) to the address generator 37 (STP20-03). The address signal (e) is reset at the time that the reset signal (b) is inputted and addresses having a period of one disk revolution and corresponding to rotational phases of the optical disk 4 are generated as shown in FIG. 18B. Subsequently, the controller 3 instructs the surface vibration component memory 20 and eccentricity component memory 26 to deliver the memorized surface vibration component and eccentricity component to the adder 19 and adder 25, respectively (STP20-04). Since in the individual steps STP19-03 and STP20-03, the reset signal (b) is outputted to the address generator 37 at times t0 and t0′ at which the rotation synchronization pulse (i) is detected, the address signal outputted from the address generator 37 is updated at the same timing from the time that the rotation synchronization pulse (i) is detected. Through this, the surface vibration component and eccentricity component are outputted which have been stored before the sleep in the surface vibration memory 20 and eccentricity component memory 26 under the condition that the address outputted from the address generator 37 and corresponding to the rotation phase of the optical disk 4 is synchronous with the rotation synchronization pulse detection timing. Thereafter, the controller 3 instructs the focus controller 18 to start focus control (STP20-05) and also instructs the tracking controller 24 to start tracking control (STP20-06), so that the focus control and tracking control are carried out such that the laser beam focuses on the recording surface of optical disk 4 and follows up a track. Subsequently, the controller 3 instructs the surface vibration component memory 20 and eccentricity component memory 26 to start memorizing the surface vibration component and eccentricity component (STP20-07) and, in accordance with the address signal (e) at the period of one revolution of the disk inputted to the controller 3 from the address generator 37, the surface vibration component and eccentricity component are memorized while being updated.

In the fourth embodiment, as shown in FIGS. 18A and 18B, the address signal (e) outputted from the address generator 37 are updated before and after the sleep at the same timing, starting from the time at which the rotation synchronization pulse is detected. Through this, the relation between the rotation phase and address remains unchanged before and after the sleep and therefore, even when the surface vibration component and eccentricity component memorized before the sleep are outputted after the sleep, the focus control and tracking control never become unstable. Further, since the focus control and tracking control are started with the surface vibration and eccentricity corrected after the sleep, the focus control and tracking control can be started stably. Further, the rotation synchronization pulse generated from the FG signal is used and therefore, the present embodiment can also be applied to an optical disk devoid of the BCA region or the rotation synchronization mark.

In the foregoing embodiments, by making the relation between the rotation phase of the disk and the address outputted from the address generator unchanged or intact before and after the sleep, the focus and tracking control can be operated stably even when the surface vibration component and eccentricity component before the sleep are used after the sleep. Similarly, by making the relation between the rotation phase of disk and the address outputted from the address generator unchanged before and after the sleep, the timing for performing focus jump or track jump stably is memorized before the sleep in correspondence with the address delivered out of the address generator, ensuring that jump can be carried out stably after the sleep by performing focus jump or track jump at the timing for the same address memorized before the sleep.

Also, in the case of an optical disk having a plurality of recording or reproduction layers, the surface vibration or eccentricity component is memorized in each layer before sleep under the condition that a specified rotation phase of optical disk and an address are synchronized with each other and besides, after the sleep, by synchronizing the specified rotation phase of the optical disk with the address, the surface vibration or eccentricity component need not be memorized again in respect of the individual layers, thereby ensuring that even when the surface vibration component and eccentricity component corresponding to each layer before the sleep are used after the sleep, the focus and tracking control can be operated stably and the host computer can be responded quickly after the sleep.

It is understood that the present invention is in no way limited to the foregoing embodiments and can be carried out in various embodiments in terms of specified constitution, function and advantage without departing from the gist of the invention.

1. An optical disk drive comprising:
an optical pickup for irradiating a laser beam on an optical disk and receiving a ray of reflection from said optical disk to output a detection signal;
a spindle motor for rotating said optical disk;
spindle motor drive means for driving rotation of said spindle motor and outputting a FG signal at intervals of predetermined rotation angles of said spindle motor;
rotation phase detection means for producing, from said FG signal, addresses corresponding to rotational phases at a period of one revolution of said spindle motor;
focus error detection means for generating from the signal detected by said optical pickup a focus error signal corresponding to a defocus of the laser beam; and
surface vibration component memory means for memorizing said focus error signal on the basis of an address delivered out of said rotation phase detection means,
wherein the address delivered out of said rotation phase detection means is synchronized with a specified rotational phase of said optical disk.

2. An optical disk drive comprising:
an optical pickup for irradiating a laser beam on an optical disk and receiving a ray of reflection from said optical disk to output a detection signal;
a spindle motor for rotating said optical disk;
spindle motor drive means for driving rotation of said spindle motor and outputting a FG signal at intervals of constant rotation angles of said spindle motor;
rotation phase detection means for producing, from said FG signal, addresses corresponding to rotational phases at a period of one revolution of said spindle motor;
tracking error detection means for generating from the signal detected by said optical pickup a tracking error signal corresponding to a displacement between the laser beam and a track; and
eccentricity component memory means for memorizing said tracking error signal on the basis of an address delivered out of said rotation phase detection means,
wherein the address delivered out of said rotation phase detection means is synchronized with a specified rotational phase of said optical disk.

3. An optical disk drive comprising:
an optical pickup for irradiating a laser beam on an optical disk and receiving a ray of reflection from said optical disk to output a detection signal;
a spindle motor for rotating said optical disk;
spindle motor drive means for driving rotation of said spindle motor and outputting a FG signal at intervals of constant rotation angles of said spindle motor;
rotation phase detection means for producing, from said FG signal, addresses corresponding to rotational phases at a period of one revolution of said spindle motor;
focus error detection means for generating from the signal detected by said optical pickup a focus error signal corresponding to a defocus of the laser beam;
surface vibration component memory means for memorizing said focus error signal on the basis of an address delivered out of said rotation phase detection means,
tracking error detection means for generating from the signal detected by said optical pickup a tracking error signal corresponding to a displacement between the laser beam and a track; and
eccentricity component memory means for memorizing said tracking error signal on the basis of an address delivered out of said rotation phase detection means,
wherein the address delivered out of said rotation phase detection means is synchronized with a specified rotational phase of said optical disk.

4. An optical disk drive comprising:
an optical pickup for irradiating a laser beam on an optical disk and receiving a ray of reflection from said optical disk to output a detection signal;
a spindle motor for rotating said optical disk;
spindle motor drive means for driving rotation of said spindle motor and outputting a FG signal at intervals of constant rotation angles of said spindle motor;
rotation phase detection means for producing, from said FG signal, addresses corresponding to rotational phases at a period of one revolution of said spindle motor;
focus error detection means for generating from the signal detected by said optical pickup a focus error signal corresponding to a defocus of the laser beam;
tracking error detection means for generating from the signal detected by said optical pickup a tracking error signal corresponding to a displacement between the laser beam and a track;
focus jump control means for determining a timing of focus jump on the basis of the address delivered out of said rotation phase detection means; and
track jump control means for determining a timing of track jump on the basis of the address delivered out of said rotation phase detection means,
wherein the address delivered out of said rotation phase detection means is synchronized with a specified rotational phase of said optical disk.

5. An optical disk drive according to claim 1, wherein said optical disk has a burst cutting area (BCA) and said rotation phase detection means outputs an address corresponding to a rotational phase in reference to the BCA formed on said optical disk.

6. An optical disk drive according to claim 1, wherein said optical disk has a synchronization detection mark formed at a specified rotational phase and synchronization detection mark detection means for detecting said synchronization detection mark is provided so that said rotation phase detection means may produce addresses corresponding to rotational phases in reference to an output of said synchronization detection mark detection means.

7. An optical disk drive according to claim 1, wherein said optical disk has a RFID formed at a specified rotational phase having a period of one revolution of said optical disk and RFID detection means for detecting said RFID is provided so that said rotation phase detection means may produce addresses corresponding to rotation phases in reference to an output of said RFID detection means.

8. An optical disk drive according to claim 1, wherein a rotation synchronization mark and synchronization detection mark detection means for detecting said synchronization detection mark are provided for a rotary part of said spindle motor, and said rotation phase detection means produces addresses corresponding to rotational phases in reference to an output of said synchronization detection mark detection means.

9. An optical disk drive according to claim 1, wherein said rotation phase detection means produces addresses corresponding to rotational phases on the basis of a period of said FG signal.

10. A surface vibration or eccentricity component memorizing method in an optical disk drive in which a laser beam is irradiated on an optical disk rotated by a spindle motor, a ray of reflection caused thereby is received to output a detection signal from which a focus error signal and a tracking error signal are generated and the focus error signal or tracking error signal is stored in a memory in accordance with an address corresponding to a rotational phase of said optical disk, said method comprising the steps of:
synchronizing said address with a specified rotation phase of said optical disk;
memorizing a focus error signal or a tracking error signal after the synchronization in accordance with an address corresponding to a rotational phase;
stopping updating memorization of focus error signal or tracking error signal during shift to a sleep mode of stopping said optical disk without taking it out; and
synchronizing again said address with the specified rotational phase of said optical disk upon recovery from the sleep mode.

11. A surface vibration or eccentricity component memorizing method in an optical disk drive in which a laser beam is irradiated on an optical disk rotated by a spindle motor, a ray of reflection caused thereby is received to output a detection signal from which a focus error signal and a tracking error signal are generated and the focus error signal or tracking error signal is memorized in accordance with an address corresponding to a rotational phase of said optical disk, said method comprising the steps of:
memorizing the correspondence between a specified rotational phase and said address;
memorizing a focus error signal or a tracking error signal in accordance with an address corresponding to a rotational phase;
stopping updating memorization of focus error signal or tracking error signal during shift to a sleep mode of stopping said optical disk without taking it out;
detecting the correspondence between the specified rotational phase of said optical disk and said address upon recovery from the sleep mode:
detecting a difference between the correspondence of the specified optical disk rotational phase with said address which has been memorized before the sleep and the correspondence of the specified optical disk rotational phase with said address which has been detected during recovery from the sleep mode; and
displacing, in accordance with the detected difference, the correspondence of data in focus error signal or tracking error signal with said address which has been stored in a memory before the sleep.

12. A surface vibration or eccentricity component memory method in optical disk drive according to claim 10, wherein the rotational speed of said optical disk during recovery from said sleep mode is made to be substantially equal to that at the time that updating memorization of the focus error signal or tracking error signal has been stopped during shift to the sleep mode.

13. A method for controlling focus jump or track jump in an optical disk drive in which a laser beam is irradiated on an optical disk rotated by a spindle motor, a ray of reflection caused thereby is received to output a detection signal from which a focus error signal and a tracking error signal are generated and a timing to perform focus jump or track jump is memorized in accordance with an address corresponding to a rotational phase of said optical disk, said method comprising the steps of:
synchronizing said address with a specified rotational phase of said optical disk;
memorizing a timing for focus jump or track jump after the synchronization in accordance with an address corresponding to a rotational phase of optical disk; and
synchronizing again said address with the specified rotational phase of optical disk upon recovery from a sleep mode.

14. A method for controlling focus jump or track jump in an optical disk drive in which a laser beam is irradiated on an optical disk rotated by a spindle motor, a ray of reflection caused thereby is received to output a detection signal from which a focus error signal and a tracking error signal are generated and a timing to perform focus jump or track jump is memorized in accordance with an address corresponding to a rotational phase of said optical disk, said method comprising the steps of:
memorizing the correspondence between a specified rotational phase of the optical disk and said address;
memorizing a timing for focus jump or track jump in accordance with an address corresponding to a rotational phase of optical disk;
detecting the correspondence between the specified rotational phase of the optical disk and said address upon recovery from a sleep mode;
detecting a difference between the correspondence of the specified rotational phase of optical disk with said address which has been memorized before the sleep and the correspondence of the specified rotational phase of optical disk with said address which has been detected during recovery from the sleep mode; and
displacing, in correspondence with the detected difference, the timing to perform focus jump or track jump which has been memorized before the sleep in correspondence with said address.
